(19) United States
(12) Patent Application Publication
(10) Pub. No.: US 2007/0102482 A1
(43) Pub. Date: May 10, 2007

(54) Assembly of a component mounted on a transfer surface

(76) Inventors: Francois Baleras, Seyssinet (FR); Christophe Kopp, Fontanil-Cornillon (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/582,953

(22) PCT Filed: Dec. 22, 2004
(86) PCT No.: PCT/FR04/50747

§ 371 Date: Jun. 15, 2006

(30) Foreign Application Priority Data
Dec. 24, 2003 (FR) 03 51204

(51) Int. Cl. A47J 36/02

(52) U.S. Cl. 228/101

(57) ABSTRACT

An optical component to be mounted on a transfer surface. At least one face of the optical component includes at least one metallized bonding land arranged in a notch for assembly by transfer of the component and soldering of metallized bonding lands on the transfer surface.

### TECHNICAL FIELD AND PRIOR ART

This invention relates to the field of microelectronic devices and more particularly optical devices. In particular it relates to a component, for example an optical component, to be mounted on a transfer surface. It also relates to a device integrating such a component, and particularly an optical device, a method of assembly of such a component and the fabrication process of this component.

FIG. 1A illustrates an example of an integrated optical device corresponding to the design of an optical bench, comprising an emitter 1 of laser radiation 2, 6 directed onto a focal lens system 4 followed by a <<microlaser>> type component 10. For example, the source 1 may be a laser emitting diode (LED) and the focal system 4, diagrammatically shown by a pair of lenses 3 and 5 may consist of an Integrated Optic Circuit or an Integrated Optic Component (IOC).

In this particular example, the resonant cell 10 is a multilayer component, usually parallelepiped in shape, composed of a body 11 made of a laser material to which a layer 12 of saturable absorbent material is bonded.

In this type of device, as can be understood from FIG. 1A, an attempt is made to position, hold and align the various optical components with each other. In particular, the laser chip must be mounted on a face perpendicular to the active faces.

FIG. 1B shows an example of a chip transfer according to the state of the art: a support platform 20 comprises a plane surface 21 on which a parallelepiped shaped chip 10 is positioned, forming an optical component like the laser resonant cell in FIG. 1A.

The chip 10 of the optical component is transferred by bringing a side face perpendicular to the faces of the end mirrors 13 and 14 into contact with the surface 21 of the platform.

The other optical components of the device 100, such as the chip 1 of the laser diode and possibly the integrated optics component corresponding to the focal system 4 may then be transferred in the same way in contact with the surface 21 of the platform 20.

The various components 1, 4 and 10 of the device are then arranged supported on the same plane 21 and can be moved on this plane so as to be positioned and aligned.

The components 1, 4 and 10 are then fixed on the platform 20 by bonding. Therefore, a drop of glue 19 is deposited under each component to be fixed before it is transferred onto its position on the surface 21 of the platform 20.

There are many disadvantages of known gluing techniques:
Glues used at the present time can damage the external structure of the component. In particular, polymers can degas and contaminate the external surfaces of the laser or pollute reflecting surfaces of mirrors in the laser cavity, which reduces or cancels out the efficiency of the laser 100.
Glues have low thermal conductivity. Yet miniature optical components release heat. In particular, the pumping energy of laser diodes and the energy absorbed in the laser <<cavity>> generate large heat losses that have to be dissipated to prevent destructive temperature rises. But heat conducting glues have a limited thermal conductivity of the order of a few Watts per meter and per Kelvin (less than 10 W/m.K).

This weakness makes it impossible to mount optical components with a high energy dissipation on a platform, which limits the power of components assembled by this technique.
The overthickness of the glue joint is difficult to control, which makes it difficult to obtain correct optical alignment. This disadvantage in the uncontrolled glue thickness has a particular disadvantage on optical devices for which optical alignment is critical, such as lasers, interfaces of optic fibres with wave guides, networks, etc.

Another problem is that the gluing technique is incapable of controlling the positioning and alignment of the transferred component. This prevents automated manufacturing of integrated optical devices.

Finally, another disadvantage is that the attachment by gluing is permanent and cannot be modified to correct it without damaging the optical device.

### DESCRIPTION OF THE INVENTION

The purpose of the invention is to assemble a component, particularly an optical component, on a transfer surface enabling a reliable and solid attachment without the above mentioned disadvantages.

One particular objective of the invention is to obtain an assembly system capable of controlling the positioning precision and alignment precision of the component, or even to automatically assemble components on their corresponding transfer surfaces.

Another purpose is to develop a technique for making an assembly system collectively on the scale of the substrate, during grouped manufacturing of components.

These objectives are achieved by providing a solder attachment of a component, particularly an optical type component, instead of a glued assembly, and by depositing one or more metallised lands on a face of the component for this purpose.

Such a bonding metallisation forms a wetting surface for soldering. Wettable surfaces are advantageously located around the periphery of the component (edges of the transfer face) and at the bottom of cavities formed at this location.

The invention relates particularly to a component, for example an optical component, that will be mounted on a transfer surface in which at least one face of the component comprises at least one metallised bonding land, used for assembly by transfer of the component and soldering of metallised bonding lands onto the transfer surface.

The arrangement of the metallised lands on the component enables an assembly onto a transfer surface.

Another advantage of the invention is that it forms a thermal bridge: meltable alloys used for solders have a thermal conductivity of the order of 10 to 50 W/m.K. This enables good dissipation of heat, particularly efficient cooling of components, for example lasers, so that finally the power of these components can be significantly increased.

Advantageously, assembly by a meltable alloy can give automatic alignment of the component on metallised positions corresponding to the surface of the transfer platform, self-alignment being effective on the three axes.

The component according to the invention may comprise a layer defining a plane. For example, this plane may be substantially perpendicular to the transfer surface.

It may comprise an active layer, for example the above layer defining a plane, for example an optically active layer.

Therefore, according to the invention, the component can be associated with a support platform forming a transfer surface and comprising metallic mounting lands corresponding to the metallised bonding lands of the component.

Each metallic bonding land may be deposited at the bottom of a corresponding assembly notch recessed below the plane external surface of the transfer face, for example around the border of the transfer face of the component.

The transfer face may comprise at least two metallised lands arranged along two opposite edges of said face, or metallised lands formed at the corners of said face, for example four metallised lands.

An intermediate element may also be arranged on the transfer face to be inserted between the component and a transfer platform, for example with a heat sink/cooler function or with a shim or optical positioning adjustment stop function.

The invention is particularly applicable to components comprising several layers of distinct media, for example optical media, arranged perpendicular to the transfer face. It is more specifically applicable to microlaser type components.

An assembly process for a component according to the invention with a platform uses a solder with added material, for example a meltable material or brazing, between each metallised bonding land of the component and the surface of the platform.

Soldering the metallised lands onto the transfer surface refers to a homogenous type solder (with or without addition of material of the same type as the metallised lands) or a heterogeneous type solder (with addition of a meltable type material).

A metallisation deposition can also be made on the surface of the platform.

Such an assembly solution can be used to arrange components at required locations on a platform at the will of the designer. The number of transferred components may be as high as wished, the only limitation being the size of the chosen platform.

Such an assembly solution facilitates assembly operations of the component, the metallised lands being easily accessible for soldering. Soldering operations can be done automatically with soldering tools that bear on the junction of the metallised lands of the component and the platform.

Another advantage is that the assembly mode of components according to the invention enables self-positioning of the component on the mounting lands of the platform and also enables passive self-alignment of the component. This is particularly advantageous in the optical field for an optical component.

Alternately, or in addition, the user can make an active alignment of the component by taking action when soldering to adjust the alignment of the component with one, two or three degrees of freedom.

If the component has several bonding lands on the transfer face, parallelism between the chip and the mounting substrate can be adjusted. The version with 4 metallised lands is the most attractive for passive assembly because self-alignment is done along both axes.

One or several recessed notches set back from the transfer surface of the component are made in advance on one or several faces of the component, a metallisation deposit at the bottom of each notch forming metallised lands set back from the transfer surface of the component.

The invention also relates to a manufacturing process for components including steps consisting of:
etching a series of parallel slits in a substrate wafer in which one or more optical components have been made, the slits being recessed from a portion of the thickness of the substrate, and
depositing a metallisation at the bottom of the slits previously etched in the thickness of the wafer.

For example, the series of parallel slits comprises slits extending longitudinally so as to form trenches or grooves in the surface of the wafer, or at least two parallel bands of short through slits in order to form a network of cavities in this surface.

Metallisation may include several operations to deposit successive layers of distinct metals, particularly three operations for successive deposition of titanium, nickel and gold to obtain an Au/Ni/Ti triple layer, and can be obtained by cathodic sputtering or metallic evaporation.

An additional step to cut components by etching can be done by chemical etching or by mechanical cutting directed along the extension of the axis of the slits, in which the cut line is narrower than the separation thickness of said slits.

### BRIEF DESCRIPTION OF THE FIGURES

Other advantages, special features and objectives of the invention will become clearer after reading the detailed description of embodiments given below only as non-limitative examples with reference to the appended drawings, wherein:
FIGS. 1A and 1B represent the arrangement and assembly of components of an optical device on a transfer surface according to a known technique;
FIGS. 2A and 2B show a first embodiment of an optical component according to the invention and its assembly on a platform;
FIGS. 3A-3F represent metallisations on the upper and the lower faces of an optical component, from underneath 3A/3D, from one side 3B/3E and from the top 3C/3F, according to the first embodiment of the invention;
FIGS. 4A-4D represent an optical component with metallisations only on the lower face, according to a second embodiment of the invention;
FIGS. 5A-5D represent an optical component with a single metallised land on the lower face, according to a third embodiment of the invention;
FIG. 6 shows a section through an optical component transferred and fixed on a platform with an intermediate element according to an alternative of the invention;
FIG. 7 shows steps 7A to 7F of a manufacturing process for a component according to the invention.

### DETAILED DESCRIPTION OF EMBODIMENTS OF THE INVENTION

In the following description, the special case of an optical component will be used as exemple.

The general principle for assembly of an optical component according to the invention is shown in FIGS. 2A and 2B that illustrate the transfer of the component 30 onto a support platform 20.

FIG. 2A shows a component for which the two faces E and F (front and back faces respectively) comprise mirror layers.

The optical component 30 considered in this case may for example be a multi-layer component of a laser resonant cell. It may be a microlaser component comprising a series of superposed layers, for example as described in document EP-A-653 824.

As shown diagrammatically in FIG. 2A, a first layer 31 made of a laser material forms the active medium of the component 30, against which a second layer 32 composed of a saturable absorbent material is attached. Finally, reflecting layers 33 and 34 forming mirrors are applied to coat the front face F and back face E.

The invention includes one or several metallised lands formed on the component. In the example illustrated, the metallised lands are arranged along the edges of the optical component chip.

In the embodiment shown in FIG. 2A, two opposite faces A and C arranged approximately perpendicular to the layers 31, 32 of the component, comprise each two metallised lands 35, 36, 37, 38 formed at the two ends of their surface, respectively.

The face A thus comprises a first metal land 37 deposited on a portion also called the distal portion, adjacent to the front face E (input mirror of the laser cell) and a second metal land 38 placed on an opposite distal portion adjacent to the back face F (output mirror of the laser cell).

The metallised lands are formed or deposited preferably at the recess of small notch shaped cuts 35, 36, 37, 38 arranged along the edges of the optical component, in this case set back along the four parallel edges C/E, C/F, A/E, A/F. Advantageously, the metallised lands exactly cover the recessed surface of said notches or cuts.

During the transfer, the face A of the chip of the optical component 30 may bear in contact with the plane surface 21 of a platform 20. The platform is made from a substrate, for example silicon, alumina, etc.

Metallised lands 25, 26 are deposited on the upper face 21 of the platform 20, at the planned transfer location of the metallised lands 37, 38 of the component 30.

According to one embodiment, the metallised mounting lands 25, 26 of the platform 20 occupy a surface area significantly larger than the planned surface area corresponding to the location of the metallised bonding lands 37, 38 of the component 30. Thus, during the transfer, the extended surface of the mounting lands 25, 26 gives a certain latitude for moving the component 30 and adjusting its positioning and alignment on several axes.

Therefore, this embodiment gives latitude for active alignment of the component (manual or mechanised alignment).

When the meltable material 27, 28 is heated to at least its melting temperature, it changes to the liquid phase. The component 30 is then aligned and positioned. When the assembly 20, 30, etc. is cooled, the meltable material 27, 28 changes back to the solid phase, so that the component 30 can be fixed.

A single metallised mounting land can cover and surround the entire surface joining the positions of all the metallised bonding lands 37, 38 of the transfer face A of a component, in other words a connected surface approximately equal to or greater than the overall section of the component 30, or the total area of the transfer face A with its notches 37, 38 inclusive.

Alternately, a single metallised mounting land can also cover a connected surface surrounding the positions of several components to be transferred.

In one simple embodiment, a major part or all of the surface 21 of the platform 20 is metallised, forming a single metallised mounting land on which a series of optical components can be arranged freely on the platform.

According to one embodiment, the metallised mounting lands 25, 26 can occupy a surface area equal to approximately the planned surface area of the metallised bonding lands 37, 38 of the component 30.

Advantageously, this surface correspondence between the metallised bonding lands 37, 38 of the component 30 and the lands 25, 26 of the platform 20 enables automatic natural positioning of the component 30 at its precise planned position on the platform 20. Such self-positioning is particularly advantageous in optics. The self-positioning effect is related to wettability forces of the soldering in the liquid phase (capillarity of the drop of solder and floating of the component on the drop in the absence of a positioning shim). Self-positioning takes place firstly along the X and Y axial directions, in other words the component is positioned in a plane parallel to the transfer surface, by a wettability effect on the metallic pads 25 and 26. Secondly, self-positioning in the axial direction Z (perpendicular to the transfer surface) is done by controlling the soldering volume.

Furthermore, as suggested by FIG. 2B, when the quantity of meltable alloy 27, 28 is reduced, the plane surface 39 projecting from the lower face A of the component 30 bears in contact with the plane surface 21 of the platform, which causes automatic alignment of the optical axis οο of the component on the optical axis of the optical device assembly.

Alternately, the quantity of meltable material 27, 28 placed in each interval 25-37 and 26-38 separating the corresponding metallised lands, can be controlled and modulated. This slightly modifies the solder thickness, and therefore the separation heights of edges of the component, which can correct the alignment of the οο axis of component 30 on the optical axis of the final assembled device.

In the first embodiment of the component illustrated in FIGS. 2, 3A, 3B, 3C, the lower bearing face A of the component 30 comprises two metallised bonding lands 37, 38 extending on the two portions called distal portions with a surface area corresponding to the front end edge E/A and to the back end edge A/F respectively. These two metallised lands 37 and 38 adjacent to the opposite edges of the chip 30 are separated by a median land 39 slightly projecting from the component.

The quantity of meltable material 27, 28 can be adjusted so as to tilt the component 30 slightly backwards. This provides a means of adjusting the alignment of the optical axis οο of the component 30 with one degree of freedom.

In one variant embodiment illustrated in FIGS. 3D to 3F, the lower bearing face 39′ of the component 30 comprises four metallised lands 37′, 37″, 38′, 38″ formed on the four corners of said face 39′ of the component. The four metallised bonding lands 37′, 37″, 38′, 38″ are preferably arranged at the recess of four cavities formed at the four corner parts of the transfer face of the component 30′. The four set back metallised lands are then separated by a cross-shaped projecting surface 39′.

By modulating the thickness of meltable alloy between each bonding land 37′, 37″, 38′ or 38″ and the corresponding mounting land (not shown), this arrangement makes it possible to adjust the inclination of the component 30′ along two tilting axes corresponding to the axes of the cross.

The advantage of such a configuration with four lands bonding at the four corners of the face of the component is that the alignment of the optical axis οο of the component can be adjusted with two degrees of freedom.

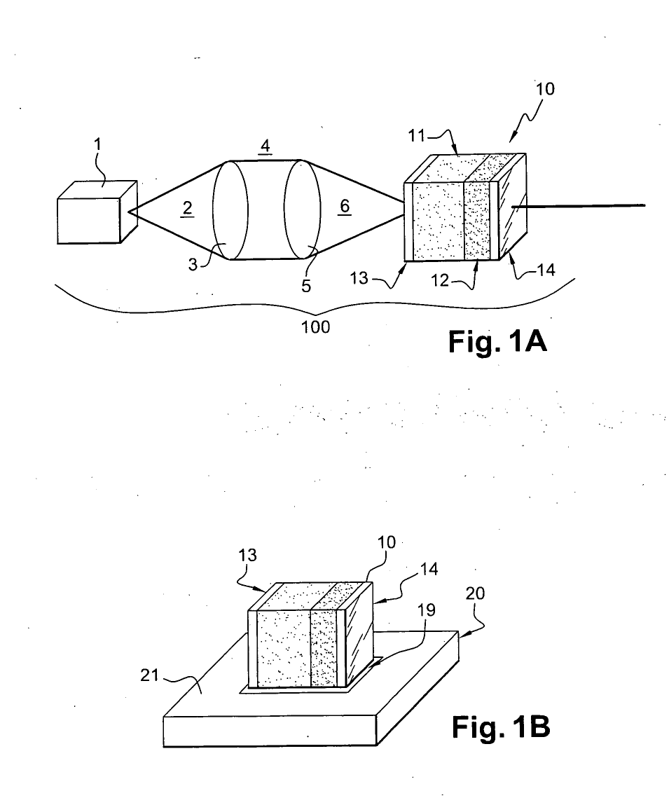

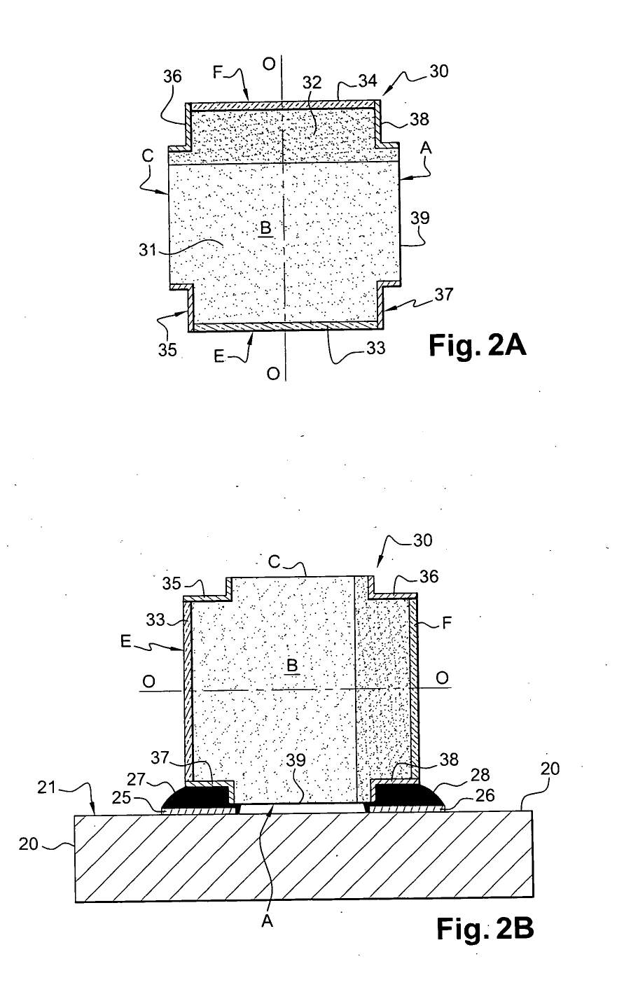

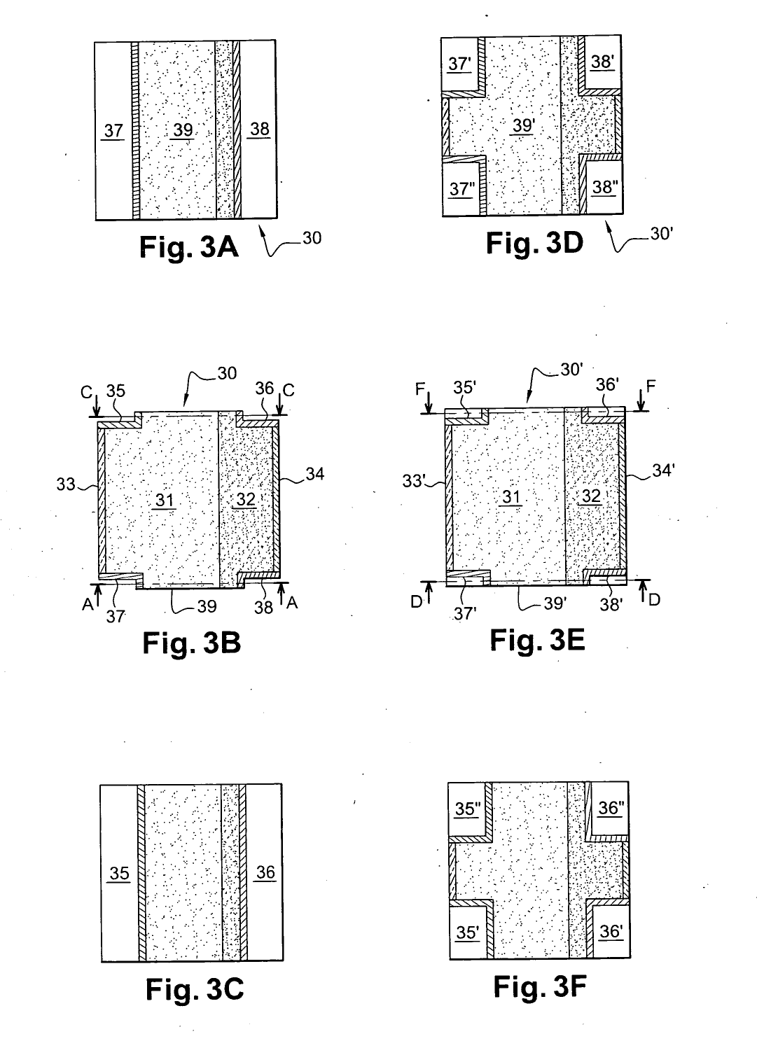

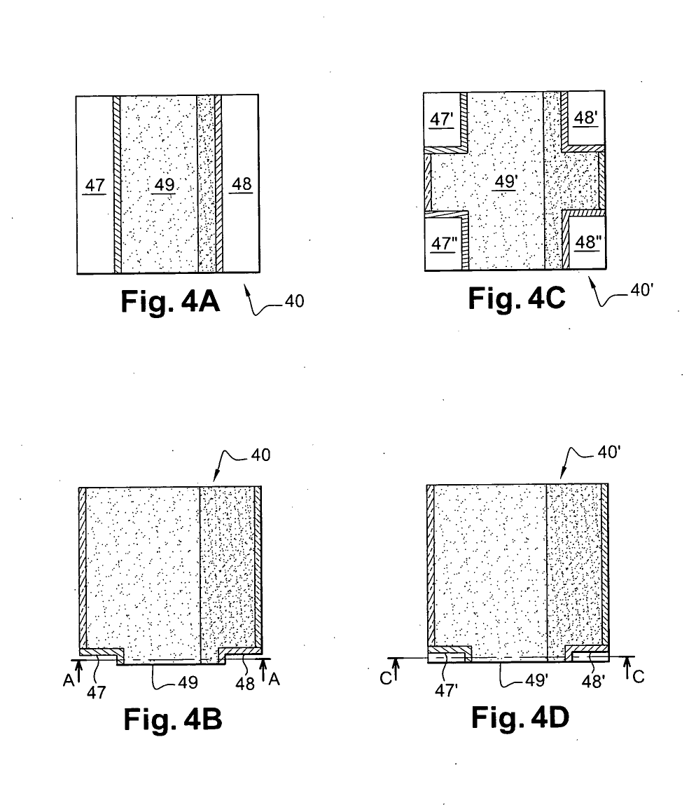

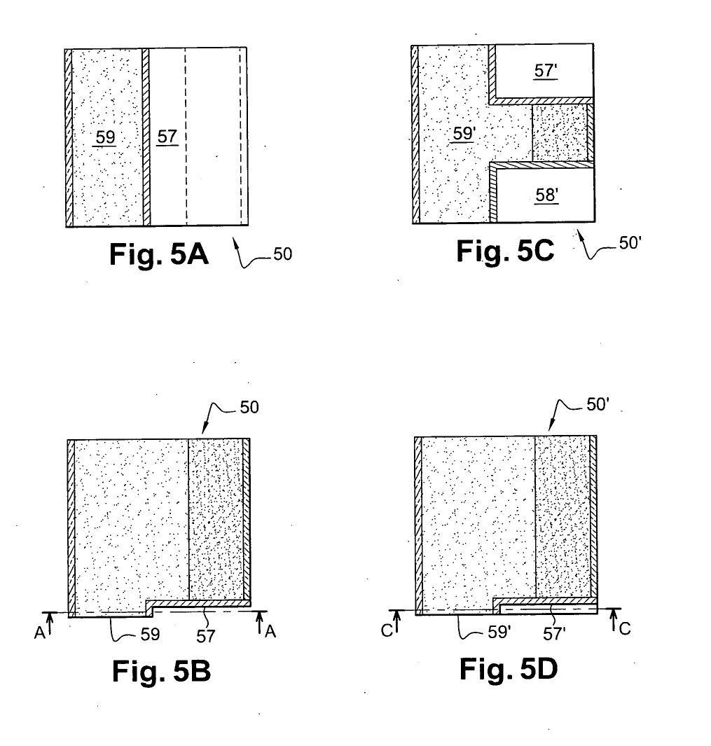

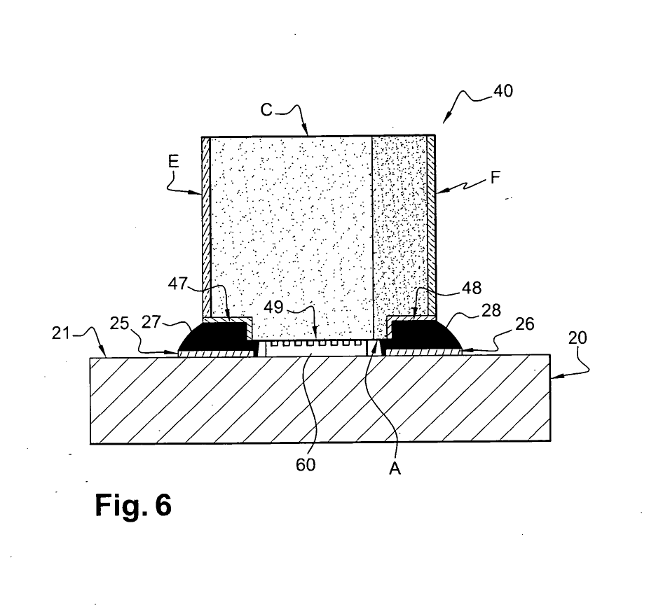

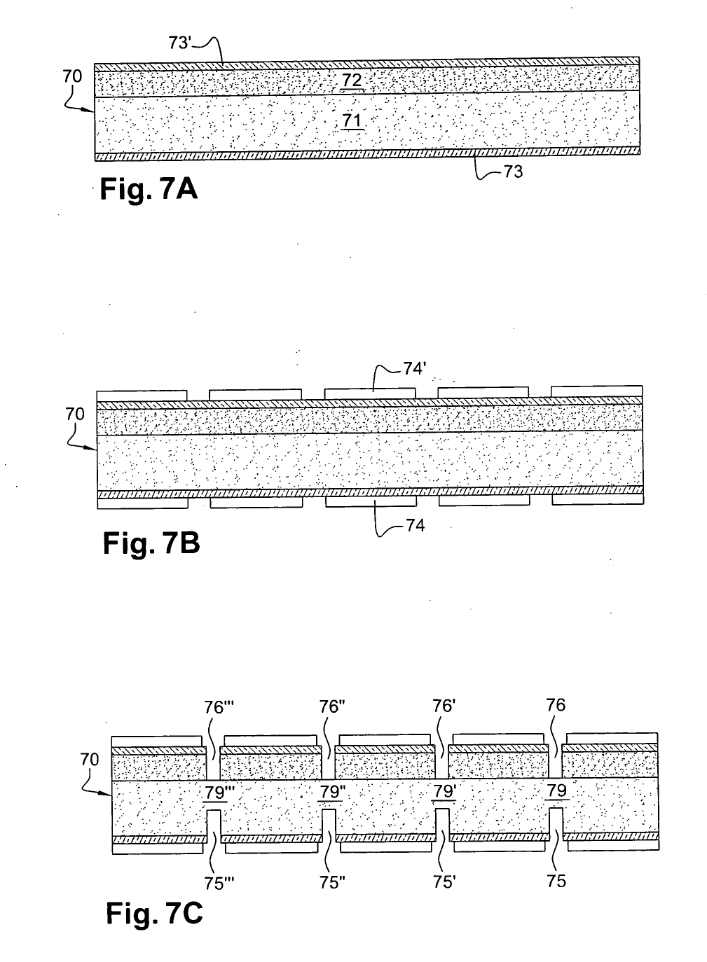

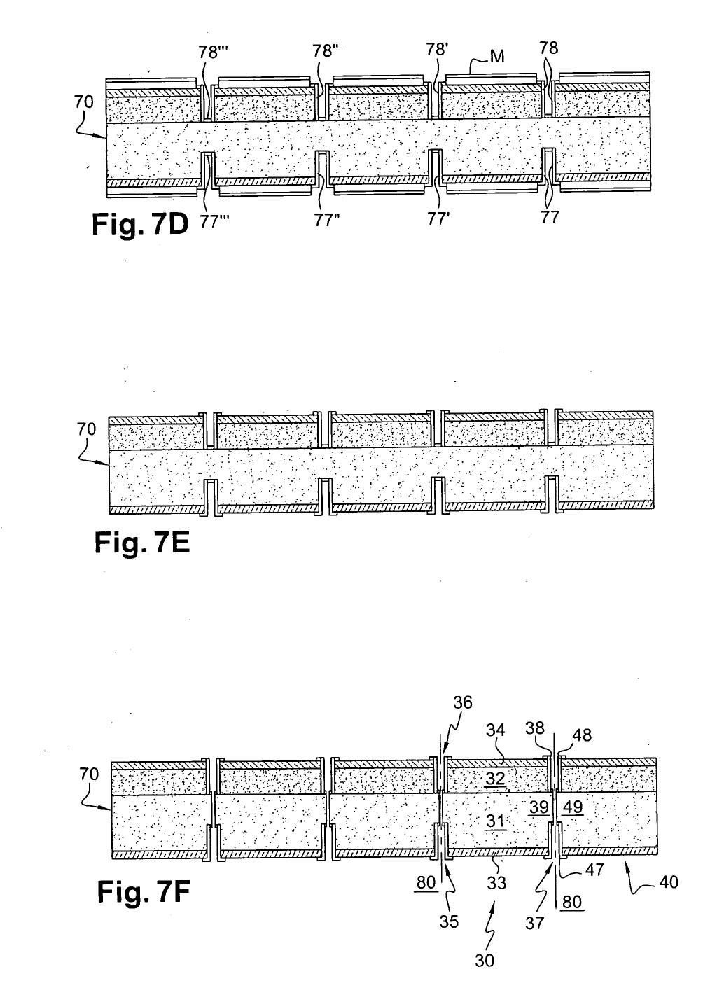

In the embodiments shown in FIGS. 2 and 3, it can be seen that the metallised bonding lands 37, 38 and 35, 36 are implanted on two opposite faces A and C of the component 30, 30′. This arrangement corresponds to the cut out of optical components after the collective manufacturing process in a substrate wafer illustrated in FIG. 7. The layout of bonding lands on opposite faces A and C of the component 30, 30′ provides a means of transferring another element in contact with the upper face C.

FIGS. 4A-4D illustrate a second embodiment in which a single face of the component 40, the lower face A (the transfer face) comprises metallised bonding lands 47 and 48.

As already described, the metallisation deposition 49 on the lower face A around a projection 49 can form two metallised lands 47 and 48 extending along two opposite end edges of said face A about a projection 49 as shown on the view 4A. Alternately, view 4C shows that four metallised lands 47′, 47″, 48′, 48″ can be formed on said transfer face about the projection 49′, within the framework of this second embodiment.

According to a third embodiment illustrated in FIGS. 5A and 5B, the lower transfer face A of the component 50 comprises a single metallised bonding land 57 deposited on a portion of the area of face A set back from the projecting surface 59 of the component 50.

View 5C also shows that alternately, the lower face A of the optical component 50 may comprise two metallic bonding pads 57′, 58′ deposited in the recesses of two cavities formed inside two corners adjacent to the face 59′ of the optical component 50′.

In the description of the embodiments given above, it is quite clear that the number, arrangement and geometric configuration of metallisation lands on the face(s) of the component can be subject of many adaptations, combinations and variations, without departing from the scope of the invention.

Note that as illustrated in FIGS. 5A, 5B, the bonding metallisation 57 preferably occupies a large part of the transfer face, or more precisely most of the sectional area of the chip 50. This arrangement is applicable to all embodiments illustrated in FIGS. 2 to 6.

The width of a mounting land is typically of the order of 50 μm to 450 μm, for example for a 1 mm wide chip.

The advantage of metallising a large part of the transfer surface is to increase the heat transfer capacity between the optical component and the support platform. Such a thermal bridge section can improve cooling of components and particularly lasers.

FIG. 6 shows another arrangement to improve heat dissipation, wherein an intermediate element 60 is mounted between the projecting surface 49 of the transfer face A of the component 40 and the surface 21 of the transfer platform 20. The intermediate element 60 performs a heat sink or cooling system function which further improves dissipation of heat energy from the device.

Another function of such an insert element 60 is to act as an adjustable positioning shim or a mechanical stop to adjust the positioning and alignment of the optical component 40.

In the invention, components are obtained using a simple and advantageous collective manufacturing process.

The technical difficulty is to make the metallisation collectively on the scale of the substrate. An optical component chip with a particular geometry is obtained by applying a specific process.

FIGS. 7A-7F illustrate steps in a process for manufacturing optical components according to the invention. The first step is to have a substrate wafer 70 in which the structure of the optical components is implanted (FIG. 7A). Depending on the scope the application example given above, the substrate contains two superposed layers 71, 72 composed of laser material 71 and a saturable absorbent material 72.

The lower and upper surfaces of the substrate 70 are then coated with reflecting layers forming mirrors 73 and 73′.

The next step (FIG. 7B) consists of depositing a photoresist on the surface or the two surfaces of the substrate wafer.

The layers 74, 74′ of photoresist (positive or negative) are insolated through an etching mask to make the required patterns. The photoresist is then developed.

A prior cut-out of the substrate can also be made.

The etching mask (not illustrated) presents a series of parallel opening slits. The length and arrangement of the slits vary depending on the required embodiment. All that is necessary to obtain recessed metallised lands extending along the opposite edges of components as in the embodiment shown in FIGS. 2, 3, 4A and 5A, is to provide a series of parallel slits extending along the longitudinal direction over the entire length of the wafer.

A chemical etching step is directed to form a series of trenches or grooves 75, 75′, 75′, 75′″, 76 . . . , excavated from the thickness of the wafer 70 (FIG. 7C).

Alternately, in order to obtain recessed metallised lands arranged only at the corners of the components as in some embodiments mentioned above, the pattern of the etching mask comprises a network of short parallel slits 75, 75′, . . . , 76′″ that follow each other transversely and longitudinally. Such slits are short, and are used to etch a network of cavities 75, 75′, . . . , 76′″ separated from each other by chemical etching.

Chemical etching is directed perpendicular to the surface towards the heart of the substrate 70, and etching is interrupted after passing through and excavating a sufficient portion of the thickness of the substrate while keeping a remaining portion 79 of the substrate intact.

If the total excavation depth of the trenches or cavities 75, . . . , 76′″ is greater than the remaining intact thickness of the substrate 79, 79′, 79″, 79′″, the bonding lands occupy most of the final surface of the components.

Advantageously, excavation of the trenches or cavities 75, . . . , 76′″ makes it possible to make a preliminary cut-out of the wafer to form the chips of future components. Advantageously, the remaining portions 79 of the wafer thickness form substrate bridges that hold the future components fixed to each other during manufacturing.

The next step (FIG. 7D) consists of depositing a bonding metallisation M on one face or on both faces of the wafer 70, for example by cathodic sputtering or by evaporation.

Several successive metallisation operations can take place to form a complex of several superposed metallised layers, for example three operations for successive deposition of titanium, nickel and gold to obtain a Ti/Ni/Au triple layer structure.

As shown in FIG. 7D, with the process according to the invention, the metallisation 77, 78 is deposited at the bottom of the trenches or cavities 75-76 excavated through the thickness of the substrate. Advantageously, the metallised layers 77′″, 78′″ cover the bottom 77′, 77″ and the sides 78′, 78″ of the trenches or cavities 75, 76.

The result is thus deposited metallised lands set back in notches or cavities formed at the location of the edges or corners of the future components.

Metallisation is followed by a step to eliminate the photoresist 74 and the excess metal M deposited on the photoresist (FIG. 7E), for example by a <<lift-off>> process that consists of dissolving the photoresist layers covering the wafer in a solvent. Since the leading edges of the photoresist layers 74 and 74′ form overhangs between the surface of the photoresist 74 and the bottom of the cavities 75-76, there is a discontinuity between the metallisation at the surface of the photoresist and the metallisation at the bottom of the trenches or cavities. Consequently, elimination of the photoresist layer detaches the excess metal layer M.

To complete the manufacturing process, the preliminary cutting operations resulting from the excavation of trenches 75, 75′, . . . , 76′″ are prolonged by a complementary cutting operation along the axis of said trenches. This final cutting step (FIG. 7F) is preferably done with a fine tool for tracing a narrow cut line 80 along the centreline of the trenches 75-76, 75′-76′, 75″-76″ and 75′″-76′″.

The result is thus chips of optical components cut out and ready to be assembled.

If the cut line 80 is narrower than the width of the trenches or cavities 77, 78, the result is a cutting surface comprising a projecting surface 39 or 49 corresponding to the bearing surface 39, 49, 59 of the component 30, 40, or 50 illustrated in FIGS. 2 to 5.

The metallised bonding lands 35, 36, 37, 38 or 47, 48 then appear to be set back at the recess of the notches that remained excavated below the projecting surface 39, 49 of the components.

As suggested in FIG. 7F, such a process can be used to obtain either components 30 comprising metallised lands 35, 36, 37, 38 on the two opposite faces A and C (corresponding to the embodiments in FIGS. 2 and 3) or components 40 comprising one or more metallised lands 47, 48 on a single face A (embodiments in FIGS. 4 to 6). An additional median cutting operation (not shown) should be included if it is required to obtain components 40 with metallisation on a single face.

The manufacturing process according to the invention has the advantage that it is particularly simple and it includes a small number of steps. In particular, the process has the advantage of combining excavation of cavities and metallisation deposit by using a single etching mask, which means that the metallisation lands can be made to correspond precisely to notch areas excavated in set back. Furthermore, metallised bonding lands and/or soldering lands are made collectively.

In the above description, the invention was applied (solely as an example) to the manufacturing of optical components with a laser cavities function, also called <<microlasers>>. Applications of the microlasers technology include a wide variety of fields such as biomedical, semiconductors industry, environment, instrumentation, metrology and telemetry. Microlaser components can be integrated into much more complex systems.

More generally, the invention is advantageously applicable to the production of multi-layer optical components, the metallised lands then being deposited on one or more side faces perpendicular to the plane of the layers, in other words to the interface plane (refracting surface) separating the optical media.

Advantageously, this arrangement of the invention can be used to deposit metallised solder bonding lands on the side faces A, B, C or D perpendicular to the front and back faces E and F that generally form the active input and output faces of the optical beams. Thus it is easy to assemble the component on a surface perpendicular to the growth plane of the component.

The invention can be extended to all applications that require assembly on a face perpendicular to the active face: networks of optical components, networks of detectors, networks of sensors, etc.

In general, the invention may be used to manufacture and assemble any type of optical component.

The term <<optical component>> used in this description denotes and surrounds components in the pure optics field, optoelectronic components and optronic components and in general components that do not form part of the lens in the strict sense of the term but that interact with light, such as emitters, sensors, detectors, fluid systems, etc.

1-28. (canceled)

29: A component to be mounted on a transfer surface, comprising:
at least one layer defining a plane in which at least one transfer face of the component, not parallel to the plane, comprises at least one metallized bonding land enabling assembly of the component by transfer and soldering of the metallized bonding lands onto the transfer surface,
wherein the at least one metallized bonding land of the component is arranged in a recessed notch set back from the surface of the transfer face.

30: A component according to claim 29, further comprising at least one active layer.

31: A component according to claim 30, wherein the at least one active layer is an optically active layer.

32: A component according to claim 29, further comprising a support platform forming a transfer surface and including metallized mounting lands corresponding to the metallized bonding lands of the component.

33: A component according to claim 29, wherein the at least one metallized bonding land is arranged at a border of the transfer face of the component.

34: A component according to claim 29, wherein the transfer face comprises at least two metallized lands arranged along two opposite edges of the transfer face.

35: A component according to claim 29, wherein the transfer face comprises four metallized lands arranged at corners of the transfer face.

36: A component according to claim 29, wherein plural faces of the component forming the transfer faces comprise metallized bonding lands.

37: A component according to claim 29, wherein the at least one metallized bonding land is arranged on each transfer face and represents a major part of the surface area of the transfer face.

38: A component according to claim 29, wherein an intermediate element is placed between the transfer face of the component and the transfer surface.

39: A component according to claim 38, wherein the intermediate element is placed between the component and the transfer surface with a shim or positioning adjustment stop function.

40: A component according to claim 38, wherein the intermediate element is a heat sink or a cooler.

41: A component according to claim 29, comprising plural layers of distinct media arranged parallel to the plane.

42: A component according to claim 29, forming an optical resonant cell for coherent light, two opposite side faces parallel to the plane comprising reflecting layers.

43: A method of assembly of a device in which at least one component including at least one layer defining a plane is transferred onto a transfer surface, the method comprising:
depositing a metallization on at least one transfer face of the component, not parallel to the plane, so as to form one or more metallized bonding lands; then,
transferring the component onto the transfer surface; and
making a solder, between each metallized bonding land of the transferred component and the transfer surface; and
prior to forming the metallized lands:
providing at least one notch excavated and set back from the transfer surface of the component in the transfer face of the component; and
depositing metallization in notches so as to form metallized lands set back from the transfer surface of the component.

44: A method of assembly according to claim 43, further comprising:
providing a support platform comprising the transfer surface for the component; and
making a metallization deposit on the surface of the platform.

45: A method of assembly according to claim 44, in which the depositing a metallization metallizes one or more mounting lands distributed around the surface of the platform, the location of the one or more metallized mounting lands corresponding to transfer locations of the metallized bonding lands of the component to be transferred.

46: A method of assembly according to claim 44, in which the depositing a metallization metallizes one or more mounting lands on the surface of the platform, each metallized mounting land corresponding and surrounding a transfer position of plural metallized bonding lands of the component to be transferred.

47: A method according to claim 43, further comprising:
excavating at least two assembly notches for each side face of the component to be transferred; and
forming at least two metallized mounting lands for each side face of a component to be transferred, so as to actively adjust an angular axial alignment of the component with respect to an axis with 2 degrees of freedom.

48: A method according to claim 43, further comprising:
excavating four assembly notches for each face of the component to be transferred; then,
forming four metallized mounting lands at bottoms of four notches of each face of the component to be transferred, so as to actively adjust an angular axial alignment of the transferred component with respect to an axis with three degrees of freedom.

49: A process for manufacturing components according to claim 29, comprising:
providing a substrate wafer comprising a blank of the component;
etching or cutting a series of parallel slits in the wafer, the slits being excavated from a portion of thickness of the substrate; and,
depositing a metallization at a bottom of the slits previously etched in the thickness of the wafer.

50: A manufacturing process according to claim 49, in which the etching comprises:
depositing at least one layer of photoresist covering at least one face of the substrate wafer;
insolating the at least one layer of photoresist through an etching mask with a series of parallel opening slits; and
performing etching through the insolated photoresist, etching extending towards a core of the substrate and stopping on one portion of the thickness of the wafer, to prevent separating the wafer.

51: A manufacturing process according to claim 49, in which the series of parallel slits includes slits that extend longitudinally so as to form trenches or grooves in the surface of the wafer.

52: A manufacturing process according to claim 49, in which the series of parallel slits includes at least two parallel strips of short transverse slits so as to excavate a network of cavities in the surface of the wafer.

53: A process according to claim 49, in which the depositing a metallization includes plural operations to deposit successive layers of distinct metals.

54: A process according to the claim 53, in which the depositing a metallization includes three operations for successive deposition of titanium, nickel, and gold to obtain a Ti/Ni/Au triple layer.

55: A process according to claim 49, in which the depositing a metallization is performed by cathodic sputtering by evaporation or by chemical vapour phase deposition.

56: A process according to claim 49, further comprising:
finishing cutting by etching of the components by performing another etching operation or mechanical cutting directed along an extension of the axis of the slits, in which a cut line is narrower than a separation thickness of the slits.
